(19) United States
(12) Patent Application Publication
(10) Pub. No.: US 2005/0262322 A1
(43) Pub. Date: Nov. 24, 2005

(54) System and method of replacing a data storage drive

(76) Inventor: Kenneth Ma, Cupertino, CA (US)

Correspondence Address: MCANDREWS HELD & MALLOY, LTD, 500 WEST MADISON STREET, SUITE 3400, CHICAGO, IL, 60661, US

(21) Appl. No.: 11/049,768

(22) Filed: Feb. 3, 2005

Related U.S. Application Data
(60) Provisional application No. 60/573,613, filed on May 21, 2004.

(51) Int. Cl. G06F 12/00

(52) U.S. Cl. 711/165; 711/112

(57) ABSTRACT

Herein described are at least a method and a system of replacing or upgrading one or more data storage drives used in a data storage device using a minimum of steps. Various aspects of the present invention describe a method of replacing or upgrading a data storage drive in a data storage device. One method utilizes an interim storage facility, provided by one or more data storage drives within the data storage device, to temporarily store data associated with the data storage drive to be replaced. Alternatively, the method may utilize a device external to the data storage device, to temporarily store data associated with the data storage drive to be replaced. One system of increasing data storage capacity of a data storage device uses a memory, software instructions resident in the memory, a processor used to execute the software instructions, and one or more data storage drives within said data storage device.

### CROSS-REFERENCE TO RELATED APPLICATIONS/INCORPORATION BY REFERENCE

This application makes reference to and claims priority from U.S. Provisional Patent Application Ser. No. 60/573,613, entitled “SYSTEM AND METHOD OF UPGRADING HARD DISK DRIVE CAPACITY”, filed on May 21, 2004, the complete subject matter of which is incorporated herein by reference in its entirety.

This application is related to and/or and makes reference to:
U.S. application Ser. No. ______ (Attorney Docket No. 15673US02) filed Feb. 3, 2005;
U.S. application Ser. No. ______ (Attorney Docket No. 15674US02) filed Feb. 3, 2005;
U.S. Application Ser. No. 60/562,847 (Attorney Docket No. 15675US01) filed Apr. 15, 2004;
U.S. application Ser. No. ______ (Attorney Docket No. 15675US02) filed Jan. 31, 2005;
U.S. application Ser. No. ______ (Attorney Docket No. 15682US02) filed Feb. 3, 2005; and
U.S. application Ser. No. ______ (Attorney Docket No. 15683US02) filed Feb. 3, 2005.

The above stated applications are hereby incorporated herein by reference in their entireties.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

As the storage capacity of a data processing or computing device reaches its maximum limit, it becomes necessary to upgrade or replace one or more of its existing storage drives. In other instances, a data storage drive may need to be replaced because of performance issues. The storage drives may comprise one or more hard disk drives. After an upgrade or replacement is performed, a user may perform a migration of data from one or more existing hard disk drives to one or more new hard disk drives, in which the one or more new hard disk drives may have larger storage capacities.

A number of complex sequence of steps and/or operations must be performed in order to accomplish this task. These tasks may include terminating the operation of any anti-virus software, backing-up and/or copying data, partitioning one or more new hard disk drives, recreating one or more folders in a directory structure, restoring data, verifying data, and interchanging hard disk drives. Further, if a hard disk drive comprises a boot disk drive, then additional steps must be taken in order to transfer data contained in an existing master boot record to one or more new hard disk drives.

During the upgrade or replacement process a user may be prevented from accessing and using the data stored within one or more hard disk drives, causing an inconvenience. Additionally, the upgrade or replacement process may take from hours to several days. As a consequence, the data migration process may be extremely difficult and challenging.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a plurality of systems and methods of upgrading or replacing one or more hard disk drives in a data storage device.

In a representative embodiment, a method of replacing or upgrading a data storage drive of one or more data storage drives in a data storage device comprises first transferring data from a first data storage drive into a second data storage drive of the data storage device, wherein the second data storage device acts as an interim storage facility. The method further comprises disconnecting from the first data storage drive and connecting to a third data storage drive, wherein the third data storage drive replaces the first data storage drive. The method further comprises second transferring the data stored in the second data storage drive into the third data storage drive.

In another representative embodiment, a method of replacing or upgrading a data storage drive of one or more data storage drives in a data storage device comprises first transferring data stored in a first data storage drive into a device external to the data storage device, wherein the device external to the data storage device provides sufficient capacity for storing the data provided by the data storage drive, and the device external to the data storage device acts as an interim storage facility. The method further comprises disconnecting from the first data storage drive and connecting to a second data storage drive, wherein the second data storage drive replaces the first data storage drive. The method further comprises second transferring the data stored in the device external to the data storage device into the second data storage drive.

In another representative embodiment, a method of replacing or upgrading a data storage drive of one or more data storage drives in a data storage device comprises first transferring data stored from a first data storage drive into two or more data storage drives resident within the data storage device, wherein the two or more data storage drives acts as an interim storage facility. The method further comprises disconnecting from the first data storage drive, accepting a second hard disk drive that replaces the first hard disk drive, and second transferring the data stored in the two or more data storage drives into the second hard disk drive.

In a representative embodiment, a system of increasing data storage capacity of a data storage device comprises a memory within the data storage device, a set of software instructions resident in the memory, a processor used to execute the set of software instructions, and one or more data storage drives within the data storage device, wherein executing the set of software instructions facilitates replacement of a data storage drive of the one or more data storage drives.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 illustrates a block diagram of a typical system incorporating the use of a network attached storage device (NAS) capable of employing seamless upgrade of one or more of its hard disk drives in accordance with an embodiment of the invention.

FIG. 2 is a block diagram of a NAS in accordance with an embodiment of the invention.

FIG. 3 is a block diagram of a NAS chip (NASoC), in accordance with an embodiment of the invention.

FIG. 4 is a diagram of a graphical user interface used by a user to select one or more hard disk drives to be replaced or upgraded in a storage device, such as the NAS, in accordance with an embodiment of the invention.

FIGS. 5A and 5B are graphical block diagrams illustrating a first hard disk drive upgrade method of a storage device (e.g., NAS), in which unallocated hard disk drive space in an existing hard disk drive provides sufficient space to act as interim storage for a hard disk drive that is to be replaced, in accordance with an embodiment of the invention.

FIG. 5C is an operational flow diagram of the first hard disk drive upgrade method, as described by FIGS. 5A and 5B, in accordance with an embodiment of the invention.

FIGS. 6A and 6B are graphical block diagrams illustrating a second hard disk drive upgrade method of a storage device (e.g., NAS), in which unallocated hard disk drive space in an existing hard disk drive provides insufficient space to act as interim storage for a hard disk drive which is to be replaced, in accordance with an embodiment of the invention.

FIG. 6C is an operational flow diagram of the second hard disk drive upgrade method, as described by FIGS. 6A and 6B, in accordance with an embodiment of the invention.

FIGS. 7A and 7B are graphical block diagrams illustrating a third hard disk drive upgrade method of a storage device (e.g., NAS), in which unallocated hard disk drive space located in one or more existing hard disk drives provides sufficient space to act as interim storage for a hard disk drive which is to be replaced, in accordance with an embodiment of the invention.

FIG. 7C is an operational flow diagram of the second hard disk drive upgrade method, as described by FIGS. 7A and 7B, in accordance with an embodiment of the invention.

FIG. 8 is an operational flow diagram illustrating how one of the three upgrade methods previously described in relation to FIGS. 5C, 6C, and 7C may be implemented, in accordance with an embodiment of the invention.

### DETAILED DESCRIPTION OF THE INVENTION

Various aspects of the invention provide at least a system and a method of replacing or upgrading one or more hard disk drives used in a data storage device. A user may wish to upgrade or increase the storage capacity of one or more data storage drives, such as one or more hard disk drives, located within a data storage device. Alternatively, the user may wish to replace the one or more data storage drives because of one or more performance related issues, such as when a hard disk drive is damaged or when a hard disk drive indicates impending failure. The previously mentioned storage device, hereinafter, may be referred to as a network attached storage device (NAS). The NAS may comprise one or more hard disk drives. As described herein, the terms “replace” or “replacing” is intended to include not only to the terms, replace or replacing, respectively, but also or alternatively to the terms, upgrade or upgrading. Likewise, the terms “upgrade” or “upgrading” is intended to include not only the terms replace or replacing, but also or alternatively to the terms, replace or replacing.

As described herein, a data storage device may comprise one or more data storage drives, such as hard disk drives, or any other type of drive. The data storage device may comprise a combination of different types of data storage drives. A data storage drive may comprise any type of media capable of storing data. Hereinafter, the term “hard disk drive” alternatively may refer to a data storage drive or any drive or component comprising a media used to store data. In a representative embodiment, one or more data storage drives or hard disk drives may be used within a data storage device. The data storage device comprises the one or more data storage drives or hard disk drives. In a representative embodiment, the data storage device provides quick replacement of the one or more additional data storage drives or hard disk drives. Various aspects of the present invention allow the capacity of the data storage device to be increased by replacing the one or more data storage drives with one or more data storage drives of larger storage capacity. Various aspects of the present invention allow one or more faulty or malfunctioning data storage drives to be replaced with new data storage drives. The size of the new data storage drives may be any size, although it is contemplated that a larger sized drive would be used to replace the faulty data storage drive.

Aspects of the invention facilitate a seamless upgrade or replacement of one or more data storage drives into the data storage device using a minimum of steps. In a first representative embodiment, a selected drive is replaced using unallocated space provided by a data storage drive of the data storage device. In a second representative embodiment, a selected drive is replaced using unallocated space provided by a device external to the data storage device. In a third representative embodiment, a selected drive is replaced using the unallocated space provided by two or more data storage devices of the data storage device. Aspects of the invention provide for an efficient and seamless data migration from one or more old hard disk drives to one or more new hard disk drives. The data migration is conveniently accomplished using a graphical user interface (GUI), in which a user uses his point and click device, such as a mouse. Aspects of the invention obviate the need for expensive and confusing data migration software. Often, the data migration requires a large number of steps to complete the data migration process. In a representative embodiment, the migration process is completed in as little as two clicks of the mouse.

Various aspects of the invention may be implemented when additional data storage drives are incapable of being incorporated into a data storage device. Aspects of the invention may provide for upgrading one or more selected data storage drives while any data storage drives that are not replaced may continue functioning normally within the data storage device. Further aspects of the invention allow preservation and complete transfer of all data or information stored within the replaced data storage drive, including any file system data structures and/or parameters. These file system data structures and/or parameters may comprise RAID, pool, share, access control, authentication, encryption password, and metadata related information. In a representative embodiment, data stored external to the data processing device is securely protected using data encryption.

In a representative embodiment, the data stored in the NAS comprises audiovisual or multimedia data. The data may comprise any type of video or audio data such as MPEG data. The data may be provided by a telecommunications carrier such as a cable operator. In other representative embodiments, the data may comprise any type of data capable of being stored in a data storage device, such as a hard disk drive. The NAS may be communicatively coupled to one or more data processing devices. The one or more data processing devices may comprise a desktop computer, a laptop computer, a PDA, a cellular phone, a digital camera, a video camcorder, digital recorder or MP3 player, or any other device capable of playing the data stored in the NAS.

In a representative embodiment, a user may administratively perform a hard disk upgrade on a data processing or computing device by accessing a GUI allowing him to specify the hard disk drive to be upgraded. The GUI may comprise at least two viewable objects such as two radio buttons or two user interface controls. For example, one user interface control allows a user to initiate or start the upgrade while the other user interface control allows a user to continue or to resume the upgrade after one or more hard disk drives are replaced. In one embodiment, the GUI is provided only when an authentication name and password is correctly input into the data processing or computing device.

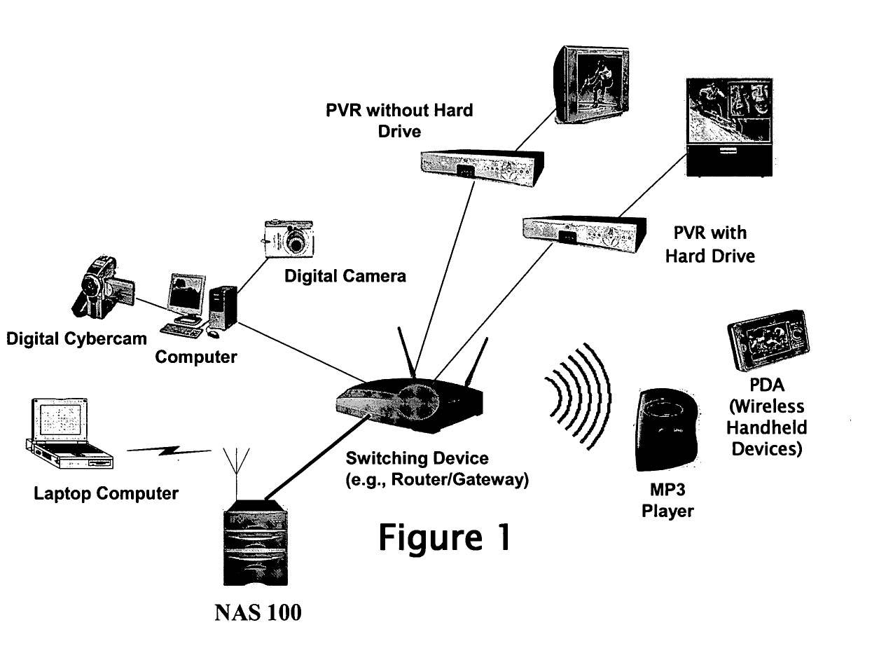

FIG. 1 illustrates a block diagram of a typical system incorporating the use of a NAS 100 capable of employing seamless upgrades of one or more of its hard disk drives in accordance with an embodiment of the invention. The NAS 100 provides data storage capability for one or more data processing or computing devices. The NAS 100 may comprise one or more hard disk drives. The one or more hard disk drives may be characterized by one or more sizes, cylinders, sectors, or any other parameters. As illustrated, a switching device provides connectivity of the NAS 100 to the one or more data processing devices. In this embodiment, the NAS 100 is connected to the switching device by way of a wireline connection. The wireline connection may comprise an Ethernet connection, for example. The NAS 100 may also communicate wirelessly as shown. In this embodiment, the NAS 100 wirelessly communicates with an exemplary laptop computer. The type of wireless communication may comprise 802.11x, Bluetooth, circuit switched cellular, or the like. The switching device is capable of providing connectivity using wireless or wireline communications. For example, a wireless router may utilize any one of the following wireless or wireline data communications protocols: 10/100 Ethernet, gigabit Ethernet, 802.11x, Bluetooth, and the like. The one or more data processing devices comprise devices such as a digital cybercam, digital camera, MP3 player, PDA, and one or more personal video recorders (PVRs). As illustrated, the PVR may be equipped with or without a hard disk drive. In one embodiment, the PVR may be referred to as a set-top-box (STB) that incorporates personal video recorder capabilities. In one embodiment, the PVR may be referred to as a PVR-STB. The PVRs illustrated, are connected to a television or a monitor capable of playing multimedia content to a home user. Use of the NAS 100 provides a centralized storage device for multimedia content received by the one or more PVRs. As a consequence of storing content in a NAS 100, PVRs lacking a storage facility, such as a hard disk drive, may store any data it receives into the NAS 100. Further, any data stored by other data processing devices, including PVRs, may be easily accessed and viewed by any of the one or more data processing devices. For example, a PVR without hard disk drive may access multimedia content originally stored into the NAS 100 by a PVR with hard drive, and vice-versa. As a result, the NAS 100 may facilitate sharing of data among the one or more data processing devices. The NAS 100 may be considered a “virtual storage device” by the one or more data processing devices. The NAS 100 is configured such that its storage capacity may be easily expanded. For example, the NAS may be configured for expansion, by providing one or more physical ports or openings in its chassis, in which the NAS 100 may receive, one or more additional hard disk drives. As such, the NAS 100 provides an easily scalable and flexible storage mechanism that accommodates for future data storage growth. In addition to its scalability, the NAS 100 provides data mirroring and data striping capabilities. The data mirroring and striping capabilities may comprise one or more RAID levels, such as RAID levels 0, 1, 0+1, 5, and 10.

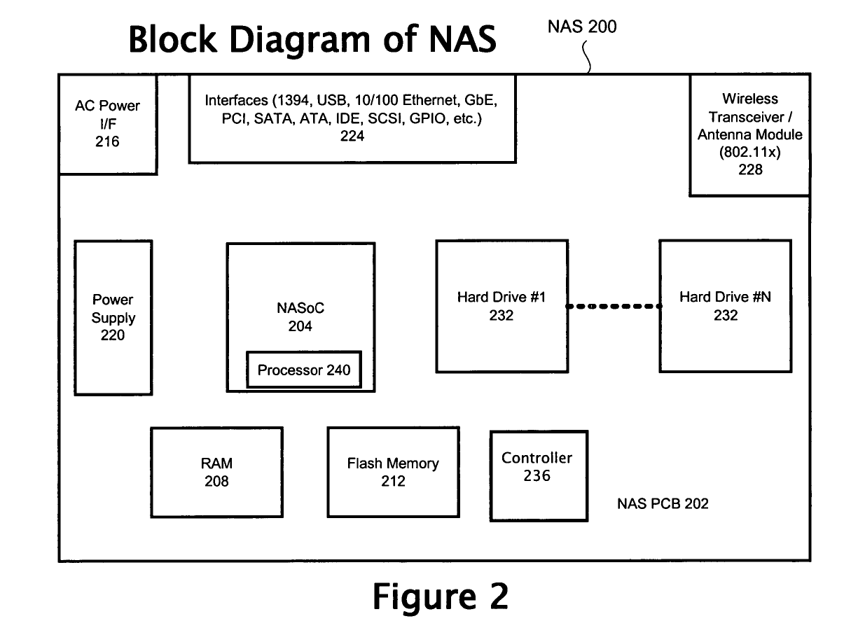

FIG. 2 is a block diagram of a network attached storage device (NAS) 200 in accordance with an embodiment of the invention. The NAS 200 comprises a printed circuit board (NAS PCB) 202 containing one or more components. The one or more components are electrically connected by way of the printed circuit board (PCB) 202. The one or more components comprises a network attached storage device on an integrated circuit chip (hereinafter, may be referred to as a NASoC) 204, a random access memory 208, a flash memory 212, an AC power interface 216, a power supply 220, a block of interfaces 224, a wireless transceiver/antenna module 228, one or more hard disk drives 232, and a controller 236. The block of interfaces 224 may comprise one or more of the following interfaces: IEEE 1394, USB, 10/100 Ethernet, gigabit Ethernet, PCI, SATA, ATA, IDE, SCSI, GPIO, or the like. The wireless transceiver/antenna module 228 may comprise an attachable module or mini-PCI card that may be optionally connected or attached to the NAS' printed circuit board 202. The wireless protocol may comprise 802.11x, Bluetooth, circuit switched cellular, or the like. The one or more hard disk drives 232 may comprise any number of hard drives depending on the design of the NAS 200. The printed circuit board 202 may be configured to accommodate an appropriate number of hard disk drives. The printed circuit board 202 may be configured to accommodate an appropriate number of hard disk drives. The number of hard drives utilized may depend on the type of mirroring or data striping (i.e., RAID) provided by the NAS 200. In one embodiment, the controller 236 provides control for any one of several devices connected to the NASoC 204. The NASoC 204 may comprise an integrated circuit chip incorporating a processor or central processing unit (CPU) 240.

The aforementioned seamless or automated disk drive upgrade may be performed by way of the NAS executing a software (or firmware) resident in a memory of the NAS. The execution of the software may be controlled and monitored by way of a personal computer (PC) communicatively coupled to the NAS. The software may be downloaded into a memory of the NAS by way of control and communication, for example, from a remote PC or other data processing or computing device. In a representative embodiment, the memory comprises the flash memory described in reference to FIG. 2. As referenced in FIG. 2, the NAS may comprise a motherboard or printed circuit board (PCB) containing the memory in which the software may be stored. In addition, the PCB may incorporate a processor or CPU that performs the execution of the software resident in the memory. In a representative embodiment, a processor or processing circuitry that is incorporated within the NASoC previously described in reference to FIG. 2 is used to execute the software in memory.

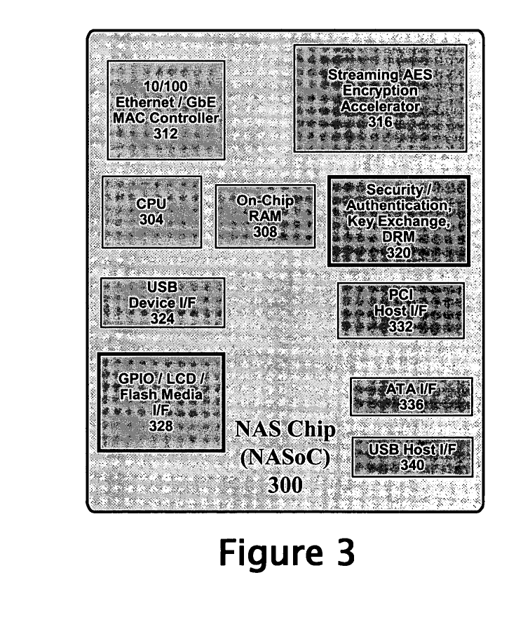

FIG. 3 is a block diagram of a NAS chip (NASoC) 300, in accordance with an embodiment of the invention. The NASoC 300 comprises an integrated circuit that is mounted on the previously described NAS PCB. The NASoC 300 provides one or more functions that allow the NAS to properly operate. In a representative embodiment, the NASoC 300 comprises a central processing unit (CPU) 304, an on-chip random access memory 308, an Ethernet/MAC controller 312, an encryption accelerator 316, a security/authentication, key exchange, digital rights management (DRM) circuitry 320, and a number of interfaces 324, 328, 332, 336, 340. The interfaces 324, 328, 332, 336, 340 may comprise, for example, the following type of interfaces: USB Device I/F 324, a PCI Host I/F 332, a GPIO/LCD/Flash Media I/F 328, an ATA I/F 336, and a USB Host I/F 340. The NAS chip 300 may communicate and/or connect to the one or more components described in reference to FIG. 2.

Referring to FIG. 2, the NAS may incorporate varying numbers of hard disk drives depending on its data storage and RAID (data mirroring and/or striping) requirements. The NAS 200 chassis may be configured to incorporate 1, 2, or 4 hard disk drives depending on type of use. For example, the NAS may utilize 4 hard disk drives for implementing RAID 10 or RAID 1+0 (both data mirroring and data striping), suitable for use in a small office/business environment. Aspects of the invention provide for using hard disk drives of different capacities, types, and/or speeds when implementing RAID functions. The NAS may utilize only 1 or 2 hard disk drives in a home (or household) environment since the storage capacity utilized is typically less than that utilized in an office or business environment. Similarly, memory components utilized in the NAS may be varied depending on type of use. As the data storage requirements increase and as the frequency of data storage related requests increase, the performance of the NAS may be improved to meet its operational needs, by way of increasing memory size of the NAS. For example, flash or DRAM memory capacities may be increased in order to improve the processing performance of the NAS. Similarly, the chassis size, power circuitry, and other components may be adjusted to meet the processing requirements of its operational environment.

In a representative embodiment, the processor 240 within the NASoC (204 or 300) executes software or firmware residing within the RAM 208 when the NAS is booted up or powered up. For example, execution of the software or firmware generates one or more user interfaces allowing a user to configure one or more data pools using portions of one or more hard disk drives. The user interfaces also facilitate configuring one or more RAID levels associated with the one or more data pools.

In a representative embodiment, execution of the software causes the http server to serve pages at a user's workstation (e.g., client workstation) facilitating the display of a desired user interface. In a representative embodiment, the software that is executed by the processor 240 comprises a configuration file that is accessed and recognized by an operating system, such as a Microsoft Windows operating system, such that it may be viewed and run by the exemplary Windows Explorer application.

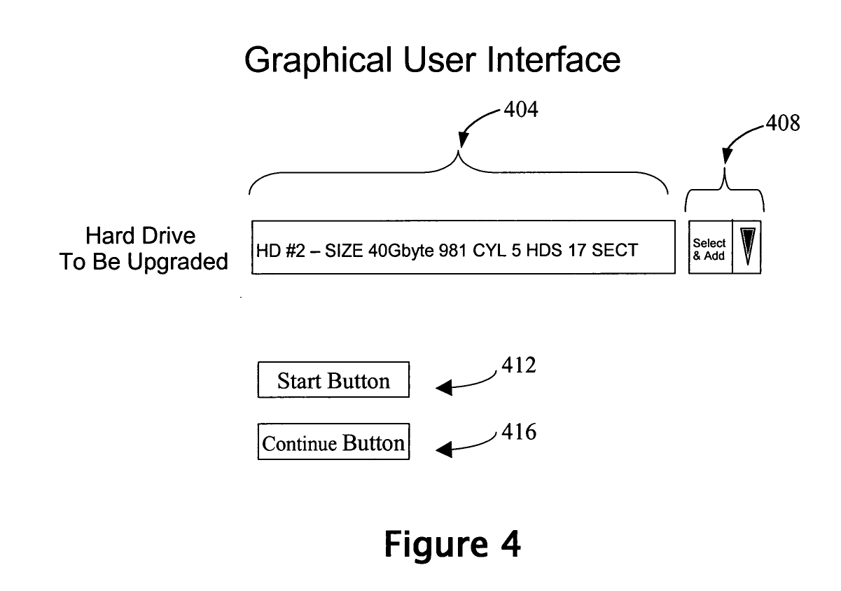

FIG. 4 is a diagram of a graphical user interface used by a user to select one or more hard disk drives to be replaced or upgraded in a data storage device, such as the NAS, in accordance with an embodiment of the invention. Shown is a field 404 used to input the one or more hard disk drives to be upgraded. The field 404 is populated by selecting a hard drive from the one or more hard drives using a pull down button 408. In this representative embodiment, hard disk drive #2 is characterized by the following parameters: Size of 40 GB (gigabytes), 981 cylinders, 5 heads, and 17 sectors. A first user interface control 412 may be used to actuate the start of the disk drive upgrade procedure. As illustrated, a second user interface control 416 may be used to resume or continue the upgrade after a storage device such as a hard disk drive is inserted into the system (e.g., NAS). The first user interface control 412 and the second user interface control 416 may each comprise a “button” viewed using the graphical user interface. The corresponding function provided by each “button” may be actuated by “clicking” on each button using a mouse, for example.

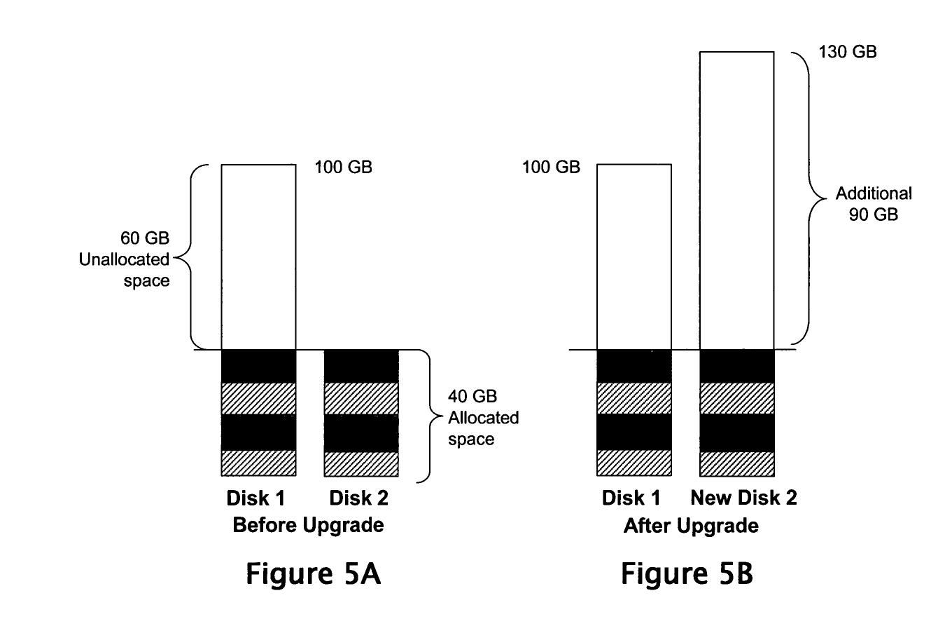

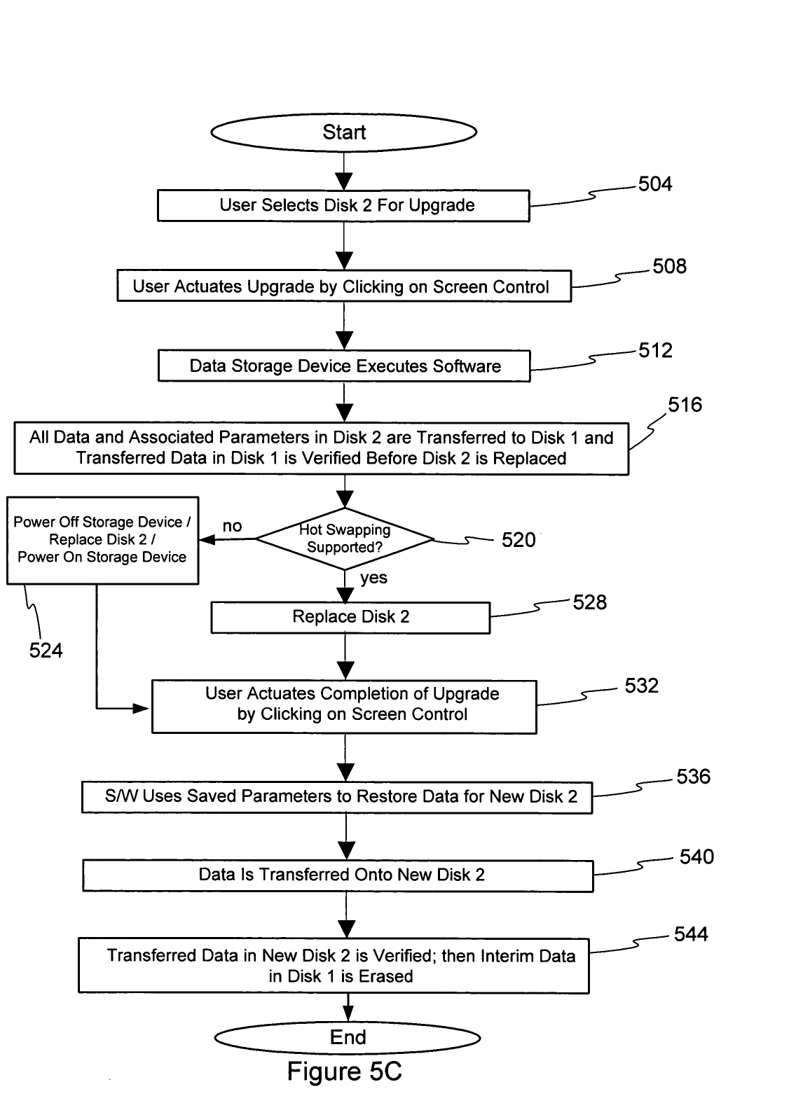

FIGS. 5A and 5B are graphical block diagrams illustrating a first hard disk drive upgrade method of a data storage device (e.g., NAS), in which unallocated hard disk drive space in an existing hard disk drive provides sufficient space to act as interim (or temporary) storage facility for a hard disk drive that is to be replaced, in accordance with an embodiment of the invention. In this exemplary embodiment, Disk 2 is replaced with a new hard disk drive since its storage capacity has reached a maximum. Disk 1 serves as a temporary or interim storage device, during the upgrade process. FIG. 5A illustrates the available unallocated space in Disk 1 that is used to temporarily store data obtained from the allocated space of Disk 2. As shown in FIG. 5A, Disk 1 provides 60 GB of unallocated space that may be used to store the 40 GB of space that occupies the entirety of Disk 2. As illustrated in FIG. 5B, the 40 GB hard disk drive of Disk 2, is replaced by a 130 GB hard disk drive. After the upgrade has been performed, Disk 2 provides 90 GB of additional unallocated space. The embodiment described in FIGS. 5A and 5B comprises only one representative embodiment of a method of upgrading a hard disk drive. In other embodiments, the disk sizes may differ from the embodiment described in FIGS. 5A and 5B. In addition, the used space in each of Disks 1 and 2 may differ from what is shown in the embodiment described in FIGS. 5A and 5B. The embodiment of FIGS. 5A and 5B describe replacing Disk 2 because it has reached its maximum capacity. In another representative embodiment, Disk 2 may be replaced because it is faulty or malfunctioning, as when a hard disk drive is ready to fail. Disks 1 and 2 may comprise one or more JBOD (Oust a bunch of disks) and/or RAID partitions. In a representative embodiment, each of the JBOD and/or RAID partitions may be shared across Disks 1 and 2.

FIG. 5C is an operational flow diagram of a first upgrade (or replacement) method used for replacing a hard disk drive in a data storage device, as described in reference to FIGS. 5A and 5B, in accordance with an embodiment of the invention. This method replaces a first hard disk drive by storing any or all data of the first hard disk drive into a second hard disk drive of the data storage device. The method utilizes a single hard disk drive as an interim storage facility. At step 504, a user may select Disk 2 for upgrade by way of using a user interface. As shown in FIG. 5A, Disk 2 has reached its maximum available capacity. The user actuates the upgrade process, at step 508, by way of a user interface control on the user interface, such as the “click to start upgrade” control described in FIG. 4. In a representative embodiment, the user clicks on a control of the user interface, using a point and click device, such as a mouse (as was described in reference to FIG. 4). At step 512, the data storage device executes a software that facilitates the upgrade process. As described in reference to FIG. 2, the NAS, for example, may comprise a flash memory used to store the software. A processor (CPU) may be used to execute or run the software. At step 516, all data and associated parameters in Disk 2 are transferred or copied to Disk 1. Should Disk 2 comprise a boot disk drive, for example, then the software may transfer data contained in an existing master boot record of Disk 2 to Disk1. The associated parameters may comprise any type of information related to partitioning the replacement hard disk drive, restoring one or more data pools and folders of Disk 2's directory structure, and verifying the transferred or copied data. The data transferred to Disk 1 may be verified before Disk 2 is replaced. Verification may comprise the use of one or more error detection and correction algorithms including but not limited to hashing algorithms. Next at step 520, the software assesses whether a data storage drive of the storage device is capable of being “hot swapped” (i.e., replaced while the storage device is powered and operational). If a “hot swap” is not possible, the process continues at step 524, at which the storage device or NAS is powered off, the hard disk (e.g., Disk 2) is replaced, and the power is turned back on. If, on the other hand, “hot swapping” is possible, the process continues with step 528, in which the user simply replaces Disk 2. In a representative embodiment, the hard disk drive may be “hot swapped” under one or more operational conditions. Disk 2 may be replaced by a new hard disk drive having a higher storage capacity. At step 532, the user facilitates completion of the upgrade by actuating a screen control, such as the “click to continue upgrade” control described in FIG. 4. Next, at step 536, the software utilizes the previously saved parameters to restore the data (e.g., one or more data pools) stored in Disk 2. At step 540, the software transfers all data stored in Disk 1 to the newly installed Disk 2 (e.g. the new hard disk drive having greater capacity). The data transfer may be facilitated by utilizing the associated parameters that were temporarily stored in Disk 1. The data storage device or NAS may use the associated parameters so as to insure proper partitioning and creation of one or more data pools and its associated data files. The parameters may also be used for restoring and verifying the data transferred from Disk 1 into the newly installed hard disk drive (new Disk 2). The data storage device or NAS may also terminate the operation of any running application or software, such as anti-virus software prior to the upgrade process described. Additionally, any master boot record, temporarily stored in Disk 1, may be seamlessly transferred onto the newly installed hard disk drive. Then, at step 544, the data transferred into new Disk 2 is verified before the temporary data stored in Disk 1 is erased. The data transferred into new Disk 2 may be rewritten and re-verified until the data has been transferred correctly.

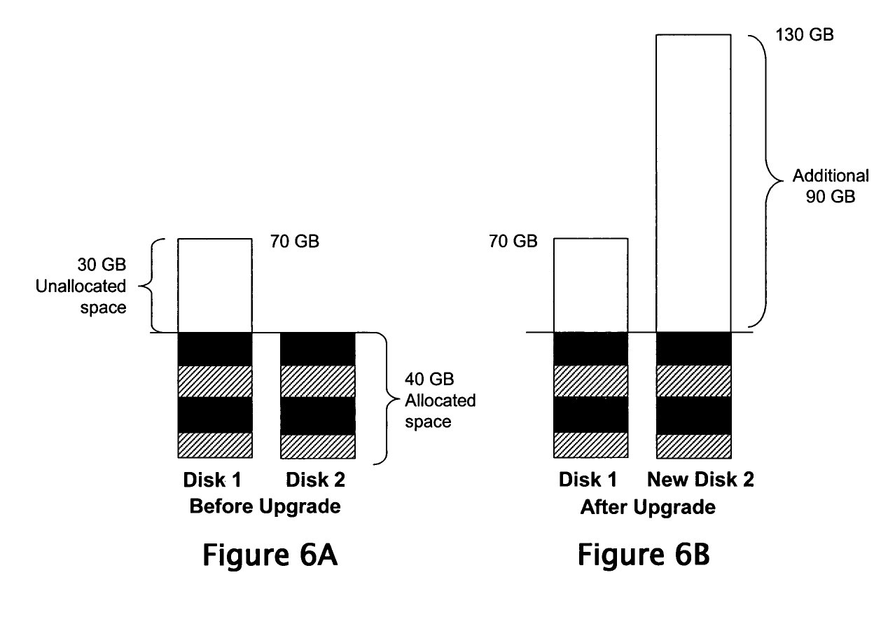

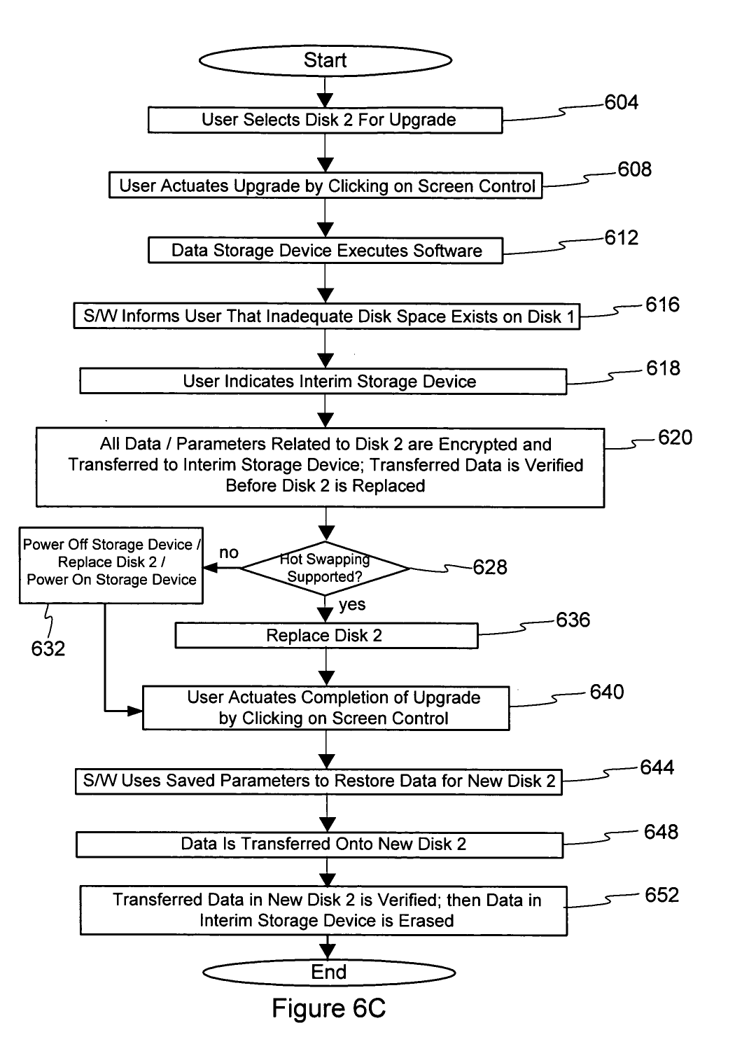

FIGS. 6A and 6B are graphical block diagrams illustrating a second hard disk drive upgrade method of a storage device (e.g., NAS), in which unallocated hard disk drive space in an existing hard disk drive provides insufficient space to act as interim storage for a hard disk drive which is to be replaced, in accordance with an embodiment of the invention. In this representative embodiment, Disk 2 is replaced with a new hard disk drive since its storage capacity has reached a maximum. However, Disk 1 cannot serve as a temporary or interim storage device, during the upgrade process, since its unallocated disk space is insufficient to hold the data occupied in Disk 2. As illustrated, 30 GB of unallocated space provided by Disk 1 is insufficient to hold the 40 GB of data stored in Disk 2. As a result, an external (i.e., external to the storage device or NAS) interim storage device is used to store the contents of Disk 2 during the upgrade process. Because the data stored into the external device may be susceptible to unauthorized access, one or more encryption/decryption algorithms may be employed to protect the data. For example, data written into the external storage device is encrypted prior to transmitting from the NAS to the external storage device, while the data read from the external storage device is decrypted at the NAS. The one or more encryption/decryption algorithms, such as a hashing algorithm, may be employed by executing a software residing in memory of the storage device or NAS. The memory used may comprise the flash memory described in relation to FIG. 2. As illustrated in FIG. 5B, the 40 GB hard disk drive is replaced by a 130 GB hard disk drive. After the upgrade has been performed, FIG. 6B illustrates that 90 GB of additional unallocated space is available in Disk 2. The embodiment described in FIGS. 6A and 6B comprises only one representative embodiment of a method of upgrading a hard disk drive. In other embodiments, the disk sizes may differ from the embodiment described in FIGS. 6A and 6B. In addition, the used space in each of Disks 1 and 2 may differ from what is shown in the embodiment described in FIGS. 6A and 6B. The embodiment of FIGS. 6A and 6B describe replacing Disk 2 because it has reached its maximum capacity. In another representative embodiment, Disk 2 may be replaced because it is faulty or malfunctioning, as when a hard disk drive is ready to fail. Disks 1 and 2 may comprise one or more JBOD (Oust a bunch of disks) and/or RAID partitions. In a representative embodiment, each of the JBOD and/or RAID partitions may be shared across Disks 1 and 2.

FIG. 6C is an operational flow diagram of a second upgrade (or replacement) method used for replacing a hard disk drive in a data storage device, as described by FIGS. 6A and 6B, in accordance with an embodiment of the invention. This method replaces a hard disk drive by temporarily storing any or all data of the hard disk drive into a device external to the data storage device. The method utilizes an external device as an interim storage facility. At step 604, a user selects exemplary Disk 2 for upgrade using a user interface or graphical user interface, since its capacity has reached its 40 GB maximum. The user actuates the upgrade process, at step 608, by way of a user interface control on the user interface, such as the “click to start upgrade” control described in FIG. 4. In a representative embodiment, the user clicks on a control of the user interface, using a point and click device, such as a mouse (as was described in reference to FIG. 4). At step 612, the data storage device executes software that facilitates the upgrade process. As described in reference to FIG. 2, the NAS, for example, may comprise a memory, such as a flash memory, used to store the software. A processor (CPU) may be used to execute or run the software. At step 616, software resident in a memory of the exemplary NAS or data storage device prompts the user that inadequate hard disk drive space exists on Disk 1. At step 618, the user indicates an appropriate alternate external storage device which may be used to store the contents of Disk 2. The external storage device may comprise a USB or an IEEE 1394 type of storage device. Next at step 620, all data and associated parameters related to Disk 2 may be encrypted and saved in the interim external storage device. The data transferred to the external storage device may be verified before Disk 2 is replaced. Next at step 628, the software assesses whether the storage device is capable of facilitating a “hot swap”. If a “hot swap” is not possible, the process continues at step 632, at which the storage device or NAS is powered off, the hard disk (e.g., Disk 2) is replaced, and the power is turned back on. If, on the other hand, “hot swapping” is possible, the process continues with step 636, in which the user simply replaces Disk 2. For example, a new hard disk drive having a higher capacity may be used as a replacement drive. At step 640, the user facilitates completion of the upgrade by actuating a user interface control, such as the “click to continue upgrade” control described in FIG. 4. Next, at step 644, the software utilizes the previously saved parameters, after decryption is performed at the NAS, in order to restore the data (e.g., one or more data pools and associated files) for Disk 2. At step 648, execution of the software facilitates the transfer of all data stored in Disk 1 to the newly installed Disk 2 (e.g, the new hard disk drive having greater capacity) after decrypting the received data. Again, the data storage device or NAS may use the associated parameters to insure proper partitioning and creation of one or more data pools and its associated data files. The parameters may also be used for restoring and verifying the data transferred from the external storage device into the newly installed hard disk drive (new Disk 2). The data storage device or NAS may also terminate the operation of any anti-virus software prior to the upgrade process described. The data storage device or NAS may also terminate the operation of any running application or software, such as anti-virus software prior to the upgrade process described. Additionally, any master boot record, temporarily stored in the external storage device, may be seamlessly transferred onto the newly installed hard disk drive. Then, at step 652, the data transferred into new Disk 2 is verified before the temporary data stored in the external storage device is erased. The data transferred into new Disk 2 may be rewritten and re-verified until the data has been transferred correctly.

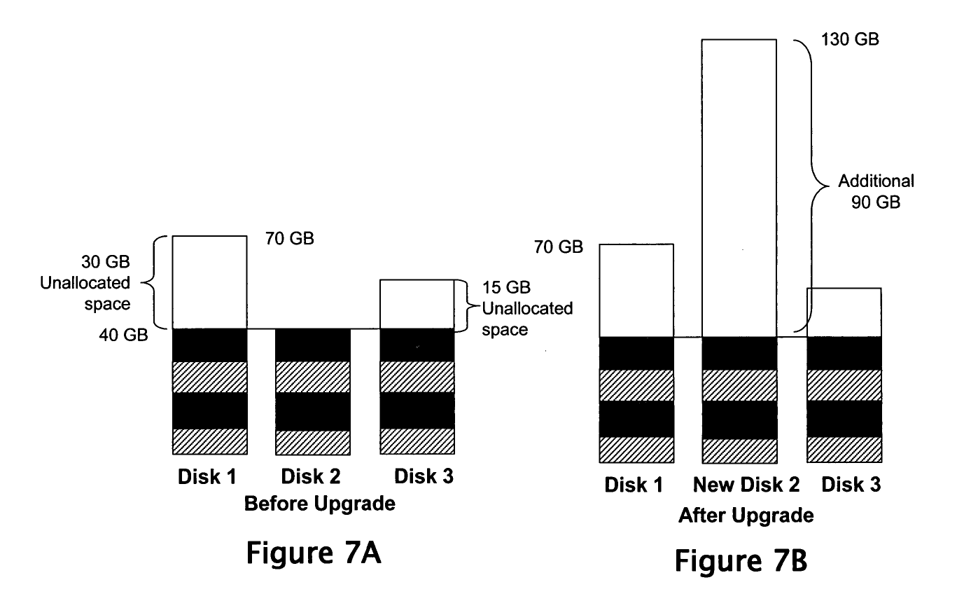

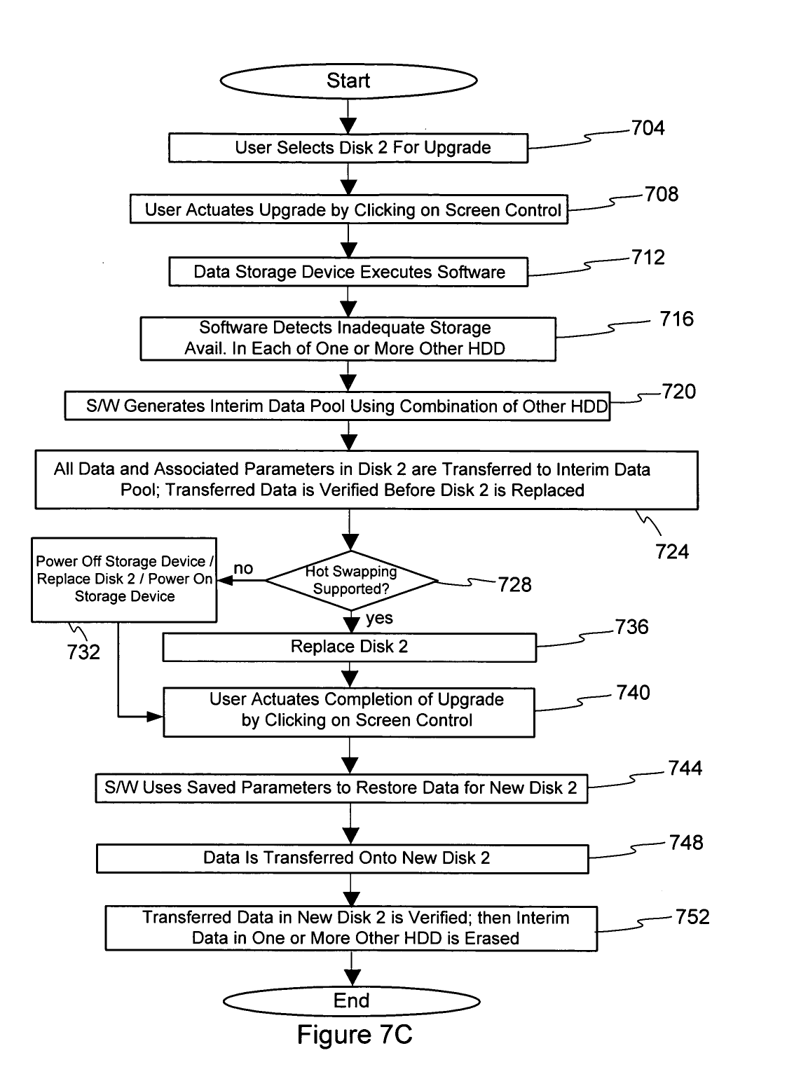

FIGS. 7A and 7B are graphical block diagrams illustrating a third hard disk drive upgrade method of a storage device (e.g., NAS), in which unallocated hard disk drive space located in two or more existing hard disk drives provides sufficient space to act as interim storage for a hard disk drive which is to be replaced, in accordance with an embodiment of the invention. In this representative embodiment, the two or more hard disk drives used to store interim data for the replaced drive (e.g., Disk 2) comprises two hard disk drives, namely Disks 1 and 3. Disk 2 is replaced with a new hard disk drive since its storage capacity has reached a maximum. As illustrated, either Disk 1 or Disk 3 independently cannot serve as a temporary or interim storage device, during the upgrade process, since their respective unallocated disk spaces are insufficient to hold the data occupied in Disk 2. As illustrated, the 30 GB of unallocated space provided by Disk 1 is insufficient to hold the 40 GB of space stored in Disk 2. Similarly, the 15 GB of unallocated space provided by Disk 3 is insufficient to hold the 40 GB of space stored in Disk 2. However, when the unallocated spaces provided by Disk 1 and Disk 3 are combined, the total unallocated space, 45 GB, is sufficient to hold the 40 GB of data stored in Disk 2, facilitating data migration during Disk 2's upgrade process. As illustrated in FIG. 7B, the 40 GB hard disk drive is replaced by a 130 GB hard disk drive. After the upgrade has been performed, FIG. 7B illustrates that 90 GB of additional unallocated space is available for Disk 2.

The embodiment described in FIGS. 7A and 7B comprises only one representative embodiment of a method of upgrading a hard disk drive. In other embodiments, the disk sizes may differ from the embodiment described in FIGS. 7A and 7B. In addition, the used space in each of Disks 1, 2, and 3 may differ from what is shown in the embodiment described in FIGS. 7A and 7B. The embodiment of FIGS. 7A and 7B describe replacing Disk 2 because it has reached its maximum capacity. In another representative embodiment, Disk 2 may be replaced because it is faulty or malfunctioning, as when a hard disk drive is ready to fail. Disks 1, 2, and 3, may comprise one or more JBOD Oust a bunch of disks) and/or RAID partitions. In a representative embodiment, each of the JBOD and/or RAID partitions may be shared across Disks 1, 2, and 3.

FIG. 7C is an operational flow diagram of a third upgrade (or replacement) method used for replacing a hard disk drive in a data storage device, as described by FIGS. 7A and 7B, in accordance with an embodiment of the invention. This method replaces a hard disk drive by storing any or all data of the hard disk drive into two or more (multiple) hard disk drives of the data storage device. The method is used when the data storage device comprises at least three hard disk drives. The method utilizes two or more hard disk drives (not including the replaced hard disk drive) as an interim storage facility. At step 704, a user selects exemplary Disk 2 for upgrade using a user interface or graphical user interface, since its capacity has reached its 40 GB maximum. The user actuates the upgrade process, at step 708, by way of a user interface control on the user interface, such as the “click to start upgrade” control described in FIG. 4. In a representative embodiment, the user clicks on a control of the user interface, using a point and click device, such as a mouse (as was described in reference to FIG. 4). At step 712, the data storage device executes software that facilitates the upgrade process. As described in reference to FIG. 2, the NAS, for example, may comprise a memory, such as a flash memory used to store the software. A processor (CPU) may be used to execute or run the software. At step 716, software resident in a memory of the exemplary NAS or data storage device prompts the user that inadequate hard disk space exists in either of the one or more hard disk drives present in the NAS. However, the software resident in the NAS determines that two or more disk drives may collectively provide adequate unallocated space in which the contents of Disk 2 may be temporarily stored. At step 720, execution of the software generates an interim data pool using the one or more hard disk drives' unallocated space. The interim data pool may be used to store the contents of Disk 2. Next, at step 724, all data and associated parameters related to Disk 2 are saved in the interim external storage device. The data transferred to the two or more hard disk drives may be verified before Disk 2 is replaced. Next at step 728, execution of the software assesses whether the storage device is capable of facilitating a “hot swap”. If a “hot swap” is not possible, the process continues at step 732, at which the storage device or NAS is powered off, the hard disk (e.g., Disk 2) is replaced, and the power is turned back on. If, on the other hand, “hot swapping” is possible, the process continues with step 736, in which the user simply replaces Disk 2. For example, a new hard disk drive having a higher capacity may be used as a replacement drive. At step 740, the user facilitates completion of the upgrade by actuating a screen control, such as the “click to continue upgrade” control described in FIG. 4. Next, at step 744, the software utilizes the previously saved parameters temporarily stored in Disks 1 and 3, in order to recreate the data (e.g., one or more data pools) for Disk 2. At step 748, the software transfers all data from Disks 1 and 3 to the newly installed Disk 2, having greater storage capacity. The data storage device or NAS may use the associated parameters so as to insure proper partitioning and creation of one or more data pools and its associated data files. The parameters may also be used for restoring and verifying the data transferred from Disks 1 and 3 into the newly installed hard disk drive (new Disk 2). The data storage device or NAS may also terminate the operation of any anti-virus software prior to the upgrade process described. The data storage device or NAS may also terminate the operation of any running application or software, such as anti-virus software, which may be running in the background, prior to the upgrade process described. Additionally, any master boot record, temporarily stored in Disk 1 and/or Disk 3, may be seamlessly transferred onto the newly installed hard disk drive. Then, at step 752, the data transferred into new Disk 2 is verified before the temporary data stored in the two or more hard disk drives is erased. The data transferred into new Disk 2 may be rewritten and re-verified until the data has been transferred correctly.

Various aspects of the present invention allow for encryption to be performed prior to temporarily transferring data into an interim storage (i.e., one or more existing internal drives or external drives). The data in interim storage is decrypted before it is transferred into one or more new data storage drives. Alternatively, in one or more embodiments, the encryption and decryption may be performed optionally or may not be performed at all when temporarily storing data into the interim storage.

Although not shown with respect to FIGS. 5A, 5B, 6A, 6B, 7A, and 7B, the various aspects of the invention allow a combination of internal and external data storage drives or hard disk drives to be used as an interim storage for the transferred data. For example, the NAS may temporarily store as much data as possible into one or more internal drives before temporarily storing any remaining data (of the disk to be replaced) into one or more external drives of one or more devices external to the NAS. Alternatively, the NAS may temporarily store as much data as possible into one or more external drives of one or more devices external to the NAS, before temporarily storing any remaining data (of the disk to be replaced) into one or more interval drives.

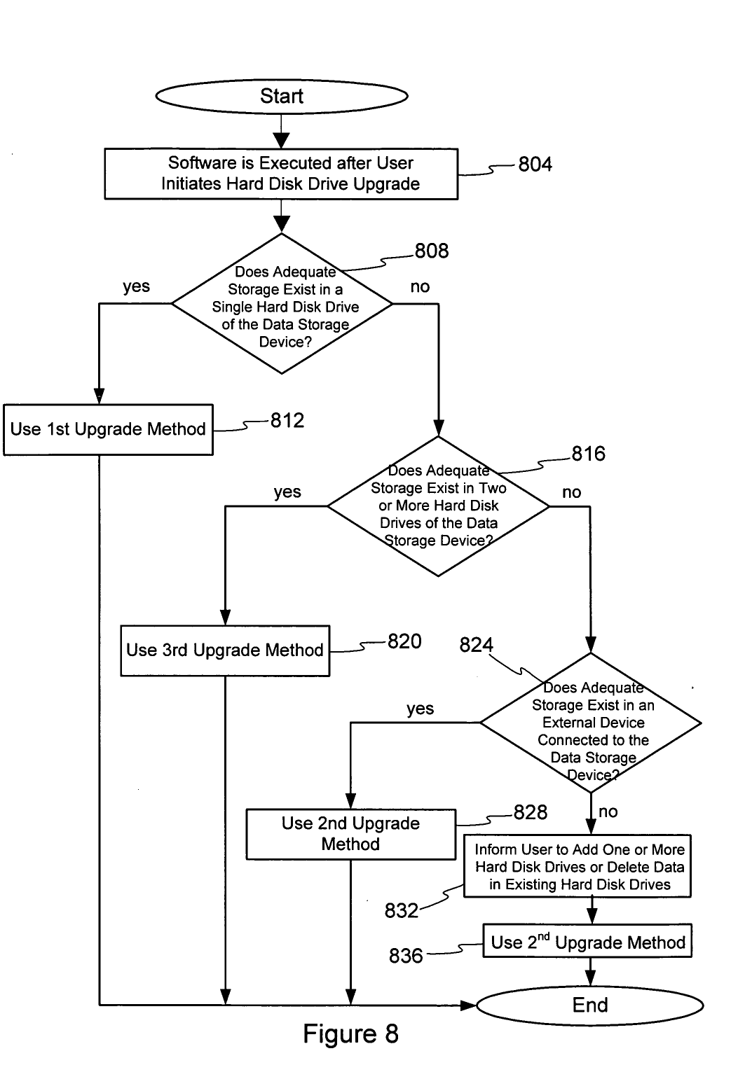

FIG. 8 is an operational flow diagram illustrating how one of the three upgrade (or replacement) methods previously described in relation to FIGS. 5C, 6C, and 7C may be implemented, in accordance with an embodiment of the invention. In this representative embodiment, the operational flow diagram describes a method of how one of the three upgrade methods are selected. The operational flow diagram is initiated when a software is executed by way of using a processor or CPU. The software may be resident in the data storage device (or NAS). At step 804, the software is executed when a user initiates a hard disk drive upgrade. The user may select a hard disk drive by way of a user interface control provided by a display. The display may be communicatively coupled to the data storage device (or NAS). The user may use a “point and click” device, such as a mouse, in order to make the selection. At step 808, a decision is made during execution of the software. The software determines whether adequate storage exists in a single hard disk drive of the data storage device, such that any or all data of a hard disk drive may be temporarily stored in the single hard drive to accommodate replacement of the hard disk drive and subsequent transfer of the data to a newly incorporated hard disk drive. The data storage device may contain a number of hard disk drives. If at step 808, it is determined that adequate storage exists in a single hard disk drive of the data storage device, the first upgrade method described in reference to FIG. 5C is used, as indicated at step 812. Otherwise, the process continues with step 816. At step 816, it is determined, during execution of the software, whether adequate storage exists in two or more hard disk drives of the data storage device to accommodate for temporary storage. If adequate storage exists, the process proceeds with step 820, at which the third upgrade method, as referenced in FIG. 7C, may be used. Otherwise, the process continues with step 824, at which it is determined whether adequate storage exists in an external device connected to the data storage device. The external storage device may communicate with the data storage device (or NAS) using any type of communication protocol, such as USB or IEEE 1394 protocols, for example. If adequate storage exists in the external device, the process proceeds to step 828, at which the second upgrade method is used, as referenced in FIG. 6B. The external storage device may provide interim storage using one or more data storage drives or hard disk drives. If inadequate storage exists in the external data storage device, at step 832, the NAS may inform the user to install one or more additional drives into the external storage device in order to provide additional capacity. The NAS may suggest to the user that certain data within the external storage device may be deleted, thereby generating additional interim storage capacity, which is sufficient for the data transfer to occur. Next, at step 836, the hard disk drive upgrade is performed using the second upgrade method, as referenced in FIG. 6B. Thereafter, the process ends. The aforementioned method provided by FIG. 8 provides a representative embodiment of how one of the three upgrade methods may be implemented. It is contemplated that the sequence or order of upgrade methods utilized in the decision making process may change or be varied as determined by a user's preferences. The sequence of upgrade methods utilized in this exemplary embodiment is as follows: 1^{st} method, 3^{rd} method, and 2^{nd} method.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A method of replacing a data storage drive of one or more data storage drives in a data storage device comprising:
first transferring data from a first data storage drive into a second data storage drive of said data storage device, said second data storage device acting as an interim storage facility;
disconnecting from said first data storage drive;
connecting to a third data storage drive, said third data storage drive replacing said first data storage drive; and
second transferring said data stored in said second data storage drive into said third data storage drive.

2. The method of claim 1 wherein said second data storage drive provides sufficient capacity for storing said data provided by said first data storage drive.

3. The method of claim 1 further comprising automatically terminating one or more applications prior to performing said disconnecting.

4. The method of claim 1 wherein said second transferring comprises completely transferring all data from said first data storage drive onto said third data storage drive.

5. The method of claim 1 wherein said replacing is performed using a graphical user interface.

6. The method of claim 5 wherein a mouse is used on one or more objects viewed using said graphical user interface.

7. A method of replacing a data storage drive of one or more data storage drives in a data storage device comprising:
first transferring data stored in a first data storage drive into one or more devices external to said data storage device, said one or more devices external to said data storage device providing sufficient capacity for storing said data provided by said data storage drive, said one or more devices external to said data storage device acting as an interim storage facility;
disconnecting from said first data storage drive;
connecting to a second data storage drive, said second data storage drive replacing said first data storage drive; and
second transferring said data stored in said one or more devices external to said data storage device into said second data storage drive.

8. The method of claim 7 further comprising automatically terminating one or more applications prior to performing said disconnecting.

9. The method of claim 7 wherein said second transferring comprises completely transferring all data from said first data storage drive onto said second data storage drive.

10. The method of claim 7 further comprising encrypting said data prior to said first transferring said data.

11. The method of claim 7 further comprising decrypting said data prior to said second transferring said data.

12. The method of claim 7 wherein said each of said one or more devices external to said data storage device comprises one or more hard disk drives.

13. The method of claim 7 wherein data is deleted from said one or more devices external to said data storage device to increase available capacity.

14. The method of claim 7 further comprising verifying and correcting said data first transferred to said one or more devices external to said data storage device.

15. The method of claim 7 further comprising verifying and correcting said data second transferred to said second data storage drive.

16. A method of replacing a data storage drive of one or more data storage drives in a data storage device comprising:
first transferring data stored from a first data storage drive into two or more data storage drives resident within said data storage device, said two or more data storage drives acting as an interim storage facility;
disconnecting from said first data storage drive;
connecting to a second data storage drive, said second data storage drive replacing said first data storage drive; and
second transferring said data stored in said two or more data storage drives into said second hard disk drive.

17. The method of claim 16 further comprising:
third transferring said data stored in said first data storage drive into one or more devices external to said data storage device; and
fourth transferring said data stored in one or more devices external to said data storage device into said second data storage drive.

18. A system for replacing a data storage drive in a data storage device comprising:
a memory within said data storage device;
software instructions resident in said memory;
a processor used to execute said software instructions; and
one or more other data storage drives, said one or more other data storage drives capable of temporarily storing data stored in said data storage drive, wherein said executing said software instructions facilitates efficient replacement of said data storage drive of said data storage device using said one or more other data storage drives.

19. The system of claim 18 further comprising an interface used to connect to one or more interim storage devices external to said data storage device, said one or more interim storage devices providing said one or more other data storage drives having sufficient capacity for said temporarily storing said data stored in said data storage drive.

20. The system of claim 19 wherein said interface comprises a USB interface.

21. The system of claim 19 wherein said interface comprises an IEEE 1394 interface.

22. The system of claim 18 wherein said memory comprises a flash memory.
